(19) United States
(12) Patent Application Publication
(10) Pub. No.: US 2021/0239122 A1
(43) Pub. Date: Aug. 5, 2021

(54) ELECTRIC COOLANT PUMP

(71) Applicant: PIERBURG PUMP TECHNOLOGY GMBH, NEUSS (DE)

(72) Inventors: ANDREAS LOEKES, WILLICH (DE); ANDREAS SAUER, KAARST (DE)

(73) Assignee: PIERBURG PUMP TECHNOLOGY GMBH, NEUSS (DE)

(21) Appl. No.: 16/972,618

(22) PCT Filed: Jun. 8, 2018
(86) PCT No.: PCT/EP2018/065164

§ 371 Date: Dec. 7, 2020

(51) Int. Cl. F04D 13/06; F04D 29/44; F04D 29/58; H02K 5/20; H02K 9/06; H02K 11/33; H02K 21/14

(52) U.S. Cl. CPC F04D 13/0626; F04D 29/445; F04D 29/588; H02K 21/14; H02K 9/06; H02K 11/33; H02K 5/207

(57) ABSTRACT

An electric coolant pump includes a pump housing, an electric motor, and a pump wheel. The pump housing includes a pumping chamber and a motor chamber. The pumping chamber includes an inlet, an outlet, and a pump volute which extends from the inlet to the outlet. The pump volute has a volute cooling sector having a radial width to axial height ratio of >1.5. A separation sidewall having a cooling section fluidically separates the motor chamber from the pumping chamber. The electric motor has a motor stator which is arranged in the motor chamber, a rotating motor rotor, and a motor electronics which is arranged in the motor chamber axially adjacent to the volute cooling sector and in a thermal contact with the cooling section. The motor electronics energizes the static motor stator. The pump wheel is arranged in the pumping chamber and is connected with the motor rotor.

### CROSS REFERENCE TO PRIOR APPLICATIONS

This application is a U.S. National Phase application under 35 U.S.C. § 371 of International Application No. PCT/EP2018/065164, filed on Jun. 8, 2018. The International Application was published in English on Dec. 12, 2019 as WO 2019/233597 A1 under PCT Article 21(2).

### FIELD

The present invention is directed to an electric coolant pump, for example, to an electric coolant pump for a motor vehicle.

### BACKGROUND

A motor vehicle electric coolant pump is typically provided to circulate a coolant of a motor vehicle cooling circuit, primarily for cooling an internal combustion engine of the motor vehicle. The electric coolant pump must be reliable and failsafe to avoid damage to the internal combustion engine. Electric coolant pumps are typically provided with an electronically commutated electric motor with a motor electronics to provide a simple electronic adaption of the pump performance to the present cooling requirements of the engine. The motor electronics generates significant heat during motor operation which must be efficiently dissipated in order to avoid an overheating of the motor electronics. The overheating of the motor electronics can cause a malfunction or failure of the electric motor and, as a result, of the coolant pump.

An electric coolant pump for a motor vehicle is described, for example, in WO 2017/220119 A1. The coolant pump is provided with a pump housing which defines a pumping chamber and a motor chamber. The pumping chamber is filled with the coolant and comprises a radially inner pump inlet, a radially outer pump outlet, and a pump volute extending from the pump inlet to the pump outlet. The motor chamber is fluidically separated from the pumping chamber by a separation sidewall extending substantially in a radial plane. The coolant pump is provided with an electric motor with a static motor stator, a rotatable motor rotor, and a motor electronics for energizing the motor stator. The motor stator and the motor electronics are arranged in the dry motor chamber. The coolant pump comprises a pump wheel which is arranged in the pumping chamber and which is co-rotatably connected with the motor rotor by an axially extending rotor shaft so that the pump wheel is driven by the electric motor.

The motor electronics is arranged axially adjacent to a volute cooling sector of the pump volute. The motor electronics is in thermal contact with the separation sidewall, in particular with a cooling section of the separation sidewall being defined by the volute cooling sector, so that the motor electronics is cooled by the coolant being pumped through the volute cooling sector and flowing along the sidewall cooling section. No additional cooling arrangements are provided for cooling the motor electronics. The sidewall cooling section area is, however, relatively small. At least parts of the motor electronics which are located radially further outside with respect to the volute cooling sector cannot therefore be cooled efficiently, which can cause a malfunction or even a failure of the electric coolant pump.

### SUMMARY

An aspect of the present invention is to provide a cost-efficient and reliable electric coolant pump.

In an embodiment, the present invention provides an electric coolant pump which includes a pump housing, an electric motor, and a pump wheel. The pump housing comprises a pumping chamber which is configured to be filled with a coolant during a pump operation, and a motor chamber. The pumping chamber comprises a radially inner pump inlet, a radially outer pump outlet, and a pump volute which is arranged to extend from downstream of the radially inner pump inlet to the radially outer pump outlet. The pump volute comprises a volute cooling sector which comprises a radial width to axial height ratio of >1.5. The motor chamber is fluidically separated from the pumping chamber by a separation sidewall which extends substantially in a radial plane. The separation sidewall comprises a cooling section. The electric motor comprises a static motor stator which is arranged in the motor chamber, a motor rotor which is configured to rotate, and a motor electronics which is arranged in the motor chamber axially adjacent to the volute cooling sector of the pump volute and in a thermal contact with the cooling section of the separation sidewall. The motor electronics is configured to energize the static motor stator. The pump wheel is arranged in the pumping chamber and is connected with the motor rotor so as to co-rotate therewith.

### BRIEF DESCRIPTION OF THE DRAWINGS

The present invention is described in greater detail below on the basis of embodiments and of the drawings in which:

FIG. 1 shows a schematic sectional side view of an electric coolant pump according to the present invention; and

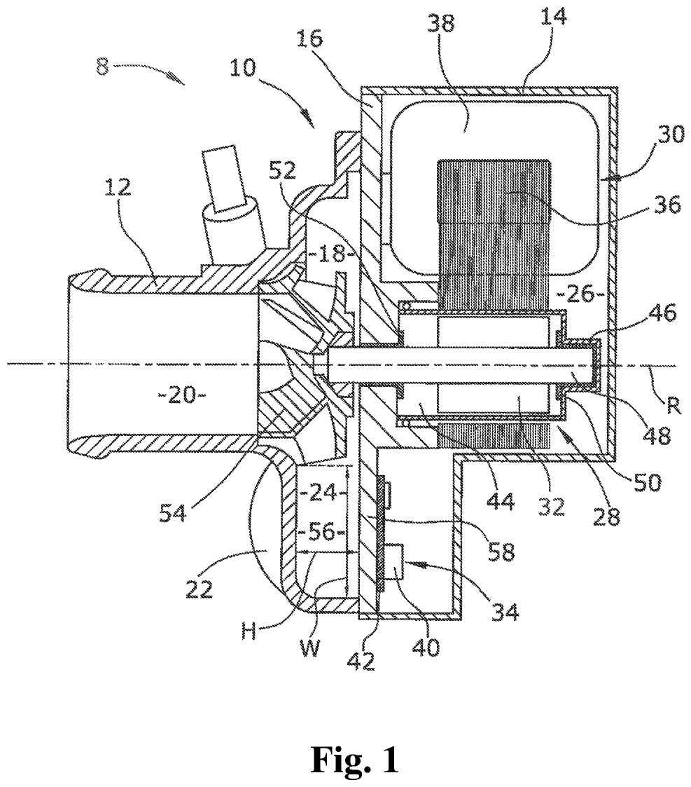

FIG. 2 shows a schematic top view of a pumping chamber cover of the coolant pump of FIG. 1.

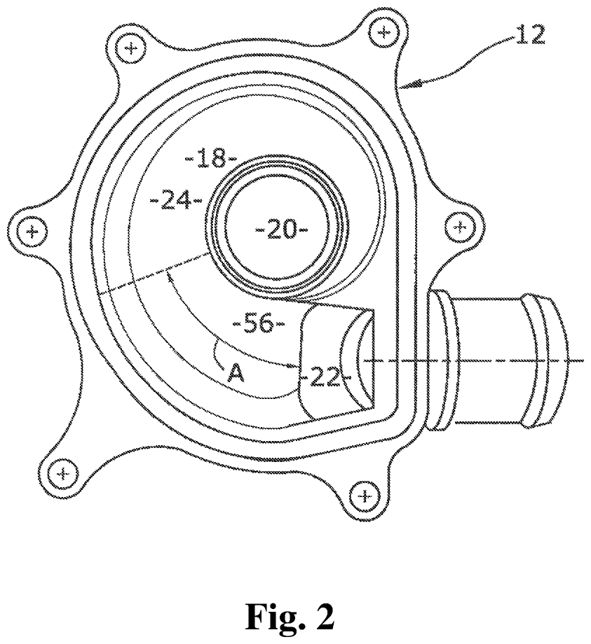

### DETAILED DESCRIPTION

The electric coolant pump according to the present invention is provided with a pump housing which defines a pumping chamber and a motor chamber, both being fluidically separated from each other by a separation sidewall which extends substantially in a radial plane. The pumping chamber is filled with a coolant during a pump operation and comprises a radially inner pump inlet and a radially outer pump outlet. The pump inlet can, for example, substantially extend in an axial motor direction and the pump outlet can, for example, substantially extend in a radial plane so that the pump inlet extends substantially perpendicular with respect to the pump outlet. The pump inlet and the pump outlet are fluidically connected by a pump volute extending from downstream of the pump inlet to the pump outlet in a radial plane. The flow cross section of the pump volute increases from the pump inlet to the pump outlet to provide an efficient coolant discharge.

The electric coolant pump comprises an electric motor with a static motor stator, a rotatable motor rotor, and a motor electronics for energizing the motor stator. The electric components, i.e., the motor electronics and the electromagnetic motor stator, are sensitive to the coolant and are therefore arranged in the dry motor chamber. The rotatable motor rotor is magnetically driven by the motor stator. The motor rotor can, for example, be permanent-magnetic so that no wear-prone sliding contacts are required to electromagnetically magnetize the motor rotor. The motor electronics is electrically connected with the motor stator and comprises several power semiconductors for commutating the driving energy of the motor stator. The power semiconductors can, for example, be arranged on a printed circuit board which is made of a material having a high thermal conductivity.

The electric coolant pump is provided with a pump wheel which is co-rotatably connected with the motor rotor so that the pump wheel is driven by the electric motor. The pump wheel can be provided integrally with the motor rotor or can alternatively be co-rotatably connected with the motor rotor, for example, by a rotor shaft. The pump wheel is arranged in the pumping chamber for pumping the coolant from the pump inlet through the pump volute to the pump outlet. The pump wheel can, for example, be located in the radial center of the pump volute so that the coolant entering the pumping chamber via the, for example, axial pump inlet flows substantially axially against the pump wheel and is accelerated radially outwardly by the rotating pump wheel.

According to the present invention, the motor electronics is located axially adjacent to a volute cooling sector of the pump volute. The volute cooling sector defines a sidewall cooling section which axially separates the volute cooling sector from the motor chamber. The sidewall cooling section is cooled by the coolant flowing through the volute cooling sector.

The volute cooling sector is provided with a radial width to axial height ratio of greater than 1.5, i.e., the radial width is at least 1.5 times as large as the axial height of the volute cooling sector. The volute cooling sector therefore defines a relatively large sidewall cooling section area for a specified flowing cross section. This allows the motor electronics to be positioned within the lateral extent of the sidewall cooling section in a radial plane, i.e., axially adjacent to the separation sidewall within the motor chamber and laterally within the lateral extent of the sidewall cooling section.

The motor electronics is in thermal contact with the sidewall cooling section so that the motor electronics can be efficiently cooled by the coolant being pumped through the pump volute. The printed circuit board of the motor electronics can, for example, be in direct contact with the sidewall cooling section. The printed circuit board can alternatively be attached to the sidewall cooling section by a heat conducting element with a high thermal conductivity. There is in any case no air gap between the motor electronics and the sidewall cooling section. No complex and therefore expensive and error-prone cooling arrangements are required for cooling the motor electronics. The electric coolant pump according to the present invention therefore provides a reliable cooling of the motor electronics if the pump is running and thereby a reliable pump operation.

The entire motor electronics can, for example, be arranged within the lateral extent of the sidewall cooling section and in thermal contact with the sidewall cooling section. Alternatively, at least power semiconductors of the motor electronics, for example, all power semiconductors of the motor electronics, are in thermal contact with the separation sidewall cooling section. Most of the heat generated in the motor electronics during the motor operation is generated by the power semiconductors of the motor electronics. A normal, efficient dissipation of the heat generated by the power semiconductors is therefore sufficient for cooling the motor electronics.

In an embodiment of the present invention, the volute cooling sector can, for example, be provided with a radial width to axial height ratio in a range of 2.0 to 2.2. This provides a large sidewall cooling section area combined with a high pump performance.

In an embodiment of the present invention, the volute cooling sector can, for example, extend over a volute angle of 70° to 90° starting at the pump outlet so that the volute cooling sector is located close to the pump outlet. This provides an especially large sidewall cooling section area because the flow cross section of the pump volute and, as a result, the sidewall cooling section area which is defined by the cooling sector, increases from the pump inlet to the pump outlet. Outside of the cooling sector, a substantial region of the pump volute can, for example, be provided with a radial width to axial height ratio of less than 1.5 to reduce the radial extent of the pump.

In an embodiment of the present invention, at least the cooling section of the separation sidewall is made of a material with a high thermal conductivity, for example, of aluminum. The thermal conductivity of the sidewall cooling section material can, for example, be higher than 10 W/(m·K); the thermal conductivity is at least higher than that of plastic materials. This provides for an efficient heat transfer from the motor electronics via the sidewall cooling section into the coolant and thereby an efficient cooling of the motor electronics.

In an embodiment of the present invention, all stator coils of the motor stator can, for example, be in thermal contact with the separation sidewall so that the at least one stator coil is cooled by the coolant pumped through the coolant pump. This provides a compact and reliable coolant pump which does not require any additional cooling means for cooling the stator coil. Besides the motor electronics, the stator coil is another significant heat source which must be cooled sufficiently to avoid a malfunction or failure of the electric motor.

In an embodiment of the present invention, the motor rotor can, for example, be arranged in a rotor chamber which is fluidically separated from the motor chamber by a separation can. The separation can extends through the air gap between the motor rotor and the motor stator and is made of a material which is permeable for the magnetic field generated by the motor stator. Since the rotor chamber is fluidically separated from the motor chamber, the rotor chamber need not be sealed against the pumping chamber. This provides a simple co-rotatable connection of the motor rotor with the pump wheel which does not require any complex sealing elements which are expensive and liable to wear.

In an embodiment of the present invention, the motor stator can, for example, comprise a single stator coil which is positioned diametrically opposite to the motor electronics. The motor stator therefore extends substantially in a single lateral direction so that free space is available close to the motor rotor at the diametrically opposite rotor side. This allows for a positioning the motor electronics very close to the motor rotor and thereby provides a compact electric fluid pump with an efficient cooling of the motor electronics.

An embodiment of the present invention is described below under reference to the drawings.

The electric coolant pump 8 comprises a multi-part pump housing 10 with a pumping chamber cover element 12, a motor chamber cover element 14, and a separation sidewall 16 substantially extending in a radial plane. In the shown embodiment of the present invention, the separation sidewall 16 is made of a material with a high thermal conductivity, for example, of aluminum. The pumping chamber cover element 12 and the separation sidewall 16 define a pumping chamber 18 which is filled with a coolant during pump operation. The pumping chamber 18 comprises a radially inner pump inlet 20, a radially outer pump outlet 22, and a pump volute 24 which extends from the pump inlet 20 to the pump outlet 22 in a radial plane. The pump inlet 20 extends substantially in an axial motor direction, and the pump outlet 22 extends substantially in a radial plane, so that the pump inlet 20 is arranged substantially perpendicular with respect to the pump outlet 22. The flow cross section of the pump volute 24, which is substantially defined by the product of its radial width W and its axial height H, increases from the pump inlet 20 to the pump outlet 22. The motor chamber cover element 14 and the separation sidewall 16 define a motor chamber 26 which is fluidically separated from the pumping chamber 18 by the separation sidewall 16.

The electric coolant pump 8 comprises an electric motor 28 with a static electromagnetic motor stator 30, a rotatable permanent-magnetic motor rotor 32, and a motor electronics 34. The motor stator 30 is provided with a laminated stator body 36 and with an electromagnetic stator coil 38 which is electrically connected with and energized by the motor electronics 34. The motor stator 30 and the motor electronics 34 are located in the dry motor chamber 26. The motor electronics 34 comprises several power semiconductors 40 which are arranged on a printed circuit board 42. The motor rotor 32 is located in a rotor chamber 44 which is fluidically separated from the motor chamber 26 by a separation can 46. The motor rotor 32 is co-rotatably fixed to a rotor shaft 48 and are rotatable about an axis of rotation R. The rotor shaft 48 is rotatably supported in the separation can 46 and in the separation sidewall 16 by two suitable shaft bearings 50,52. The rotor shaft 48 extends axially from the rotor chamber 44 into the pumping chamber 18.

The electric coolant pump 8 comprises a pump wheel 54 which is located in the pumping chamber 18 for pumping the coolant from the pump inlet 20 through the pump volute 24 to the pump outlet 22. The pump wheel 54 is co-rotatably connected with the rotor shaft 48 so that the pump wheel 54 is driven by the electric motor 28. The pump wheel 54 is arranged within the pumping chamber 18 so that the coolant entering the pumping chamber 18 via the pump inlet 20 flows substantially axially against the pump wheel 54 and is accelerated radially outwardly by the rotating pump wheel 54.

The motor electronics 34 is located axially adjacent to a volute cooling sector 56 of the pump volute 24. The volute cooling sector 56 extends over a volute angle A starting at the pump outlet 22 and running in a pump-inlet-facing circumferential direction of the pump volute 24. The volute cooling sector 56 extends over a volute angle A of 80° in the shown embodiment of the present invention. The volute cooling sector 56 defines a sidewall cooling section 58 which axially limits the volute cooling sector 56 towards the motor chamber 26. The sidewall cooling section 58 is cooled by the coolant flowing through the volute cooling sector 56. The volute cooling sector 56 is provided with a radial width W to axial height H ratio which is greater than 1.5, i.e., the radial width W is at least 1.5 times as large as the axial height H of the volute cooling sector 56. The radial width W to axial height H ratio is in a range of 2.0 to 2.2 in the shown embodiment of the present invention.

The motor electronics 34 is laterally positioned within the lateral extent of the sidewall cooling section 58 and diametrically opposite to the stator coil 38. The printed circuit board 42 of the motor electronics 34 is in direct thermal contact with the separation sidewall cooling section 58. The motor electronics 34, in particular all power semiconductors 40 of the motor electronics 34, are thereby efficiently cooled by the coolant being pumped through the pump volute 24 during pump operation.

The present invention is not limited to embodiments described herein; reference should be had to the appended claims.

### LIST OF REFERENCE NUMERALS

8 electric coolant pump

10 pump housing

12 pumping chamber cover element

14 motor chamber cover element

16 separation sidewall

18 pumping chamber

20 pump inlet

22 pump outlet

24 pump volute

26 motor chamber

28 electric motor

30 motor stator

32 motor rotor

34 motor electronics

36 stator body

38 stator coil

40 power semiconductors

42 printed circuit board

44 rotor chamber

46 separation can

48 rotor shaft

50 shaft bearing

52 shaft bearing

54 pump wheel

56 volute cooling sector

58 sidewall cooling section

A volute angle

H axial height

R axis of rotation

1-8. (canceled)

9. An electric coolant pump comprising:
a pump housing comprising:
a pumping chamber which is configured to be filled with a coolant during a pump operation, the pumping chamber comprising:
a radially inner pump inlet,
a radially outer pump outlet, and
a pump volute which is arranged to extend from downstream of the radially inner pump inlet to the radially outer pump outlet, the pump volute comprising a volute cooling sector which comprises a radial width to axial height ratio of >1.5, and
a motor chamber which is fluidically separated from the pumping chamber by a separation sidewall which extends substantially in a radial plane, the separation sidewall comprising a cooling section;
an electric motor comprising,
a static motor stator which is arranged in the motor chamber,
a motor rotor which is configured to rotate, and a motor electronics which is arranged in the motor chamber axially adjacent to the volute cooling sector of the pump volute and in a thermal contact with the cooling section of the separation sidewall, the motor electronics being configured to energize the static motor stator; and
a pump wheel which is arranged in the pumping chamber and which is connected with the motor rotor so as to co-rotate therewith.

10. The electric coolant pump as recited in claim 9, wherein the motor electronics comprises power semiconductors each of which are in a thermal contact with the cooling section of the separation sidewall.

11. The electric coolant pump as recited in claim 9, wherein the radial width to axial height ratio of the volute cooling sector is 2.0 to 2.2.

12. The electric coolant pump as recited in claim 9, wherein the volute cooling sector extends over a volute angle of 70° to 90° starting at the radially outer pump outlet.

13. The electric coolant pump as recited in claim 9, wherein the cooling section of the separation sidewall is made of a material which has a high thermal conductivity.

14. The electric coolant pump as recited in claim 9, wherein the static motor stator comprises stator coils each of which are in a thermal contact with the separation sidewall.

15. The electric coolant pump as recited in claim 9, further comprising:
a rotor chamber having the motor rotor arranged therein; and
a separation can which is configured to fluidically separate the rotor chamber from the motor chamber.

16. The electric coolant pump as recited in claim 9, wherein the static motor stator comprises a single stator coil which is arranged diametrically opposite to the motor electronics.
